(19) United States
(12) Patent Application Publication
(10) Pub. No.: US 2010/0030814 A1
(43) Pub. Date: Feb. 4, 2010

(54) SYSTEM, METHOD, OR APPARATUS RELATING TO A DATA STRUCTURE WITH A LARGE NUMBER OF ENTRIES

(75) Inventors: Patrick Wong, Milpitas, CA (US); Jason Rupp, San Francisco, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: YAHOO! INC., Sunnyvale, CA (US)

(21) Appl. No.: 12/184,825

(22) Filed: Aug. 1, 2008

(51) Int. Cl. G06F 17/30; G06F 7/00

(52) U.S. Cl. 707/200; 707/E17.005

(57) ABSTRACT

Embodiments of methods, apparatuses, devices, and systems associated with a data structure having a large number of entries are disclosed.

### FIELD

Embodiments relate to the field of data structures, and more specifically to data structures having a large number of entries.

### BACKGROUND

The World Wide Web includes vast amounts of information and a variety of applications. For example, various organizations provide e-mail access to one or more users. At one or more times, it was not uncommon for those organizations to place one or more limits on a user's e-mail storage. For example, a user may have been limited to a particular quantity of data associated with an e-mail account. However, as limits on user storage have increased over time one or more challenges have been encountered for e-mail providers. Accordingly, under some circumstances, it is desirable to develop new techniques for handling ever increasing quantities of data.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a flow-chart diagram of a representation of a method or process in accordance with an embodiment;

FIG. 2 is a schematic diagram of system or process in accordance with an embodiment; and

FIG. 3 is a schematic diagram of a system in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components or circuits that would be known by one of ordinary skill have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

The World Wide Web includes vast amounts of information and a variety of applications. For example, various organizations provide e-mail access to one or more users. At one or more times, it was not uncommon for those organizations to place one or more limits on a user's e-mail storage. For example, a user may have been limited to a particular quantity of data associated with an e-mail account. However, as limits on user storage have increased over time one or more challenges have been encountered for e-mail providers. Accordingly, under some circumstances, it is desirable to develop new techniques for handling ever increasing quantities of data.

As limits on e-mail data, such as e-mail data associated with one or more web based e-mail providers, have increased over time new solutions have been desirable to address one or more issues. For example, as a quantity of messages in an e-mail folder has increased a corresponding increase in storage capacity and computing capacity has been needed to keep pace. As just one example, a larger number of e-mails in a folder at least in part results in an increased computing burden on one or more back-end or system maintenance processes. For example, a back-end or system maintenance process may from time to time open a user's e-mail folder at least in part to perform one or more clean-up tasks. Clean-up tasks may include purging of messages marked for deletion, movement of messages marked to be moved from one folder to another, sorting one or more messages by a category, such as date, if a folder has at least one region sorted by such a category and at least one region not sorted such a category, or the like. For example, newly received messages may be initially place in an unsorted region until a back-end or system maintenance process sorts those new messages. For another example, if a user deletes an e-mail from a folder, that e-mail, while no longer visible to a user in that folder, may remain in that folder until a back-end or system maintenance process associated with the e-mail provider opens that folder and processes the deletion. As the size of a particular folder increases the back-end or system maintenance process will may deal with ever larger quantities of data in order to process the deletions, folder moves, etc. This may result in a need for more processing power or more memory usage by the back-end process and a computing platform associated with the back-end process.

Embodiments, as described more fully below, may at least in part address one or more of the above-described challenges. In an embodiment, a system or process may address the above issues at least in part by utilizing a folder, a metadata file associated with the folder, and one or more virtual sub-folders associated with the folder. For example, if an e-mail user exceeds a threshold range associated with a quantity of e-mails in a folder a system or process may create one or more virtual sub-folders for e-mails in that folder in excess of the threshold range. In addition, a system or process may update a metadata file to track the one or more virtual sub-folders and associated e-mail messages. Furthermore, if a user deletes or moves an e-mail file the metadata folder may be updated to indicate a quantity of pending deletions, moves, or the like. In this way, a back-end or maintenance process may analyze the metadata file to determine whether any further processes are desirable at a given time. For example, a back-end process may analyze a metadata file at least in part to determine whether a threshold quantity of deletions, moves, or the like has been reached with respect to a folder or a virtual sub-folder. If a threshold quantity has been reached then a back-end process may open a corresponding folder or virtual sub-folder to perform an appropriate clean up process, such as processing one or more deletions, moves, or the like. If, however, a threshold quantity has not been reached the back-end process may not need to expend any resources opening the corresponding folder or virtual sub-folder. In addition, a back-end process may utilize a metadata file at least in part to manage virtual sub-folder creation and contraction. For example, if a metadata file indicates that a folder or virtual sub-folder exceeds a threshold range associated with a quantity of active e-mails a back-end process may create an additional virtual sub-folder for subsequent e-mails received by that folder or virtual sub-folder. For another example, if a metadata file indicates that one or more of a folder or virtual sub-folders have a quantity of active e-mail such that at least one less virtual subfolder could adequately address the quantity of active e-mail a back-end process may remove a virtual subfolder and associate any e-mails in the removed virtual sub-folder with another virtual sub-folder or folder. It should, however, be noted that these are merely illustrative examples relating to e-mail folders or back-end processes and that claimed subject matter is not limited in this regard.

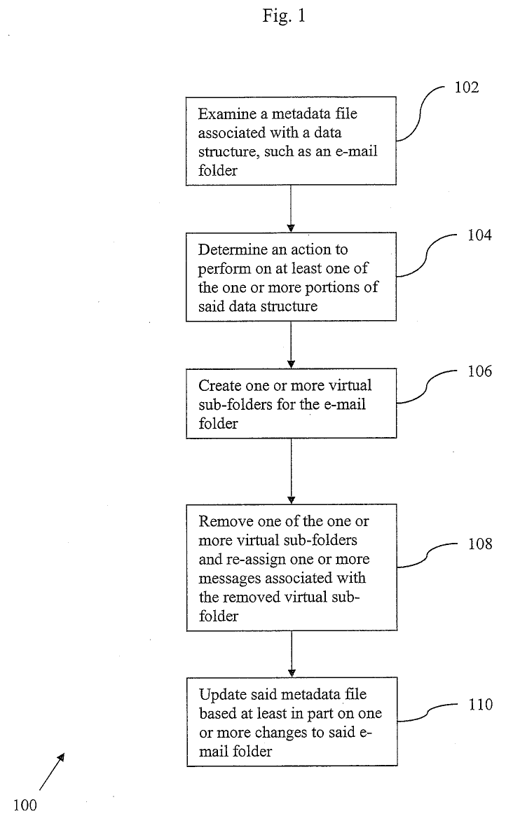

FIG. 1 is a flow-chart diagram of a representation of a method or process in accordance with an embodiment 100. With regard to embodiment 100, a system or process may examine a metadata file associated with a data structure, such as an e-mail folder, for example, as shown in box 102. As used herein, the term data structure refers an expression of information. For example, a data structure may comprise any system, apparatus, method, or process at least in part operable to organize a collection of data in a manner such that the data may, at least in part, be manipulated. For example, a data structure may comprise a table, an index, a database, or a directory, to name but a few examples. For further example, a data structure may comprise one or more e-mail folders associated with one or more e-mail accounts, without regard to how those e-mail folders and corresponding e-mails are stored. In an example embodiment, a back-end e-mail system or system maintenance process may examine a metadata file associated with one or more e-mail folders or e-mail virtual sub-folders. In this example, a back-end or system maintenance process may examine such a metadata file at least in part to determine whether one or more threshold ranges are present. As used herein, a “metadata file” refers to a data file at least in part pertaining to other data. For example, a metadata file may include data at least in part pertaining to one or more other data structures or data files. In an embodiment, a metadata file may comprise information relating to an e-mail folder and one or more virtual sub-folders. For example, a metadata file may be associated with an e-mail folder and may comprise any of the following information associated with that e-mail folder: a quantity of active messages; a quantity of total message, e.g., active messages, deleted messages, and moved messages; a date range associated with the folder and any virtual subfolders, e.g., a date where messages in a folder or virtual sub-folder begin, and a date, if known, on which messages end. For example, a folder may include e-mail messages received starting on a particular date. If a folder or virtual sub-folder has reached a threshold range then it may also include a date passed which new messages are no longer associated with that folder or virtual sub-folder and are instead associated with a new virtual sub-folder. Here, a threshold range may comprise a quantity of e-mail moves, e-mail deletions, new e-mail, active e-mail, or the like.

Based at least in part on the examination or a metadata file, a back-end system or process may determine one or more actions to perform on a folder or one or more virtual subfolder as shown in box 104, for example. For example, if a quantity or new or active e-mails associated with a folder or virtual sub-folder exceeds a threshold range, such as 25,000 to 75,000 e-mails, a back-end system or process may create one or more virtual subfolders for the folder at least in part so that new e-mails intended for that folder may be associated with the newly created virtual sub-folder as shown in box 106. For an additional example, if a quantity of e-mail in at least two of a folder and one or more virtual sub-folders is small enough a back end system or process may remove one or more of the virtual sub-folders and re-assign any e-mails associated with the removed virtual sub-folder(s) to one or more remaining folders or virtual subfolders as shown in box 108. In this example, if re-assigning the e-mails from the virtual subfolder would not result in a folder or virtual sub-folder approaching the threshold value discussed above it may be beneficial to re-assign those e-mails to one of the other folders or sub-folders and remove a virtual sub-folder. In addition, after processing deletions, moves, creation of virtual sub-folder, removal of virtual sub-folders, changes in quantity of new mail, or quantity of active mail a system or process may update the metadata file to reflect a current status for a folder or sub-folder as shown in box 110. It should, however, be noted that this is merely an illustrative example relating to a data structure or backend processes and that claimed subject matter is not limited in this regard.

It should be noted that, although aspects of the above system or process have been described in a particular order, the specific order is merely an example of a process and claimed subject matter is of course not limited to the order described. It should also be noted that the methods and processes described herein, may be capable of being performed by one or more computing platforms. In addition, the methods or processes described herein may be capable of being stored on a storage medium as one or more machine readable instructions, that if executed may be adapted to enable a computing platform to perform one or more actions. “Storage medium” as referred to herein relates to media capable of maintaining expressions, which may be operated on, or executed by, by one or more machines. For example, a storage medium may comprise one or more storage devices for storing machine-readable instructions or information. Such storage devices may comprise any one of several media types including, for example, magnetic, optical or semiconductor storage media. However, these are merely examples of a storage medium and claimed subject matter is not limited in these respects.

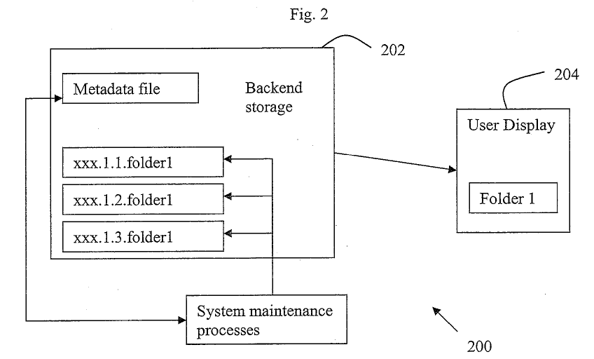

FIG. 2 is a schematic diagram of system or process in accordance with an embodiment 200. With regard to embodiment 200, a system or apparatus may comprise a computing platform 202. In an embodiment, computing platform 202 may comprise back-end storage associated with a data service, such as a web-based e-mail system or process, for example. In an embodiment, a system may include one or more folders associated with a user. For example, folder 1 may be associated with a user, such as a user employing computing platform 204. In an embodiment, folder 1 may appear to a user as a single folder as shown on a user display associated with computing platform 204. For example, a user may view folder 1 as a single folder within a graphical user interface, such as a web browser logged into a web-based e-mail system. However, in back-end storage at computing platform 202, folder 1 may be represented by a folder, one or more subfolders, and a metadata file, for example. In this embodiment, from a perspective of back-end storage at computing platform 202, folder 1 may comprise folder xxx.1.1.folder1 along with virtual sub-folders xxx.1.2.folder1 and xxx.1.3.folder1, etc. As discussed above, a system maintenance process may from time to time examine the metadata file at least in part to determine whether one or more actions may be desirable to perform on folder xxx.1.1.folder1. For example, if a quantity of messages in folder xxx.1.1.folder exceeds a threshold range, such as 25,000 to 50,000 individual e-mail entries, it may be desirable to create one or more virtual sub-folders for subsequently received e-mails. For example, a system maintenance process may create virtual sub-folder xxx.1.2.folder1. In this example, e-mail in excess of a threshold range for folder xxx.1.1.folder1 may now, instead, be associated with virtual sub-folder xxx.1.2.folder1.

Furthermore, additional e-mails received for folder 1 may subsequently be associated with virtual sub-folder xxx.1.2.folder1. A system maintenance process may similarly create an additional virtual sub-folder, such as virtual sub-folder xxx.1.3.folder1 if a quantity of e-mail exceeds a threshold range in virtual sub-folder1.2.folder1. In an embodiment, there is no set upper bound for a number of virtual sub-folders that may be created. For example, as an e-mail folder continues to grow a system maintenance process may create one or more subsequent virtual sub-folders as earlier created virtual sub-folders meet or exceed a threshold range. In this manner, a system may allow an e-mail user to have an unbounded quantity of e-mail associated with any particular folder. It should, however, be noted that these are merely illustrative examples relating to e-mail folders and that claimed subject matter is not limited in this regard.

With regard to FIG. 2, a system maintenance process, such as a back-end process, may further examine the metadata file at least in part to determine whether one or more other actions may be desirable. For example, a user may, such as by using a graphical interface associated with computing platform 204, mark one or more e-mail messages in folder 1 for deletion. In this example, the one or more e-mail messages marked for deletion may not be immediately deleted. For example, the one or more e-mail messages marked for deletion may be hidden from view to the user. However, those one or more e-mail messages marked for deletion may still be associated with folder 1 at computing platform 202. For example, those e-mail messages marked for deletion may include a tag indicating that they are to be deleted during system maintenance. Furthermore, the metadata file may be updated, such that a number of files to be deleted may be included in a description of any applicable virtual sub-folders. In an embodiment, a system maintenance process may determine that it is desirable to process e-mail marked for deletion at least in part from an examination of the updated metadata file. For example, if a quantity of e-mail marked for deletion in a folder or any virtual-subfolder exceeds a threshold range, such as 100 to 300 e-mails marked for deletion, a percentage of e-mail marked for deletion, such as 1 to 5 percent of a total quantity of e-mails in a folder or virtual sub-folder, and up to a high end value such as a quantity on the order of 10,000 e-mails marked for deletion, such a system maintenance process may open a corresponding folder or virtual sub-folder and process the deletions. Furthermore, in addition to processing the messages marked for deletion, the system maintenance process may further update the metadata file to indicate that a folder or virtual sub-folder no longer has pending deletions. Alternatively, a system maintenance process may be scheduled to, from time to time, such as once a day, once a week, once a month etc., process any e-mails marked to be deleted. In this embodiment, the system maintenance process may examine the metadata file at one or more scheduled times and open any virtual sub-folders with pending e-mails to be deleted at least in part to open a corresponding folder or virtual sub-folder and process the pending deletions. Furthermore, the system maintenance process may also update the metadata file to indicate that pending deletions for a folder or virtual sub-folder have been completed. It should, however, be noted that this is merely an illustrative example relating to a system maintenance process and that claimed subject matter is not limited in this regard.

With regard to FIG. 2, a system maintenance process, such as a back-end process, may further examine the metadata file at least in part to determine whether one or more other actions may be desirable. For example, a user may, such as by using a graphical interface associated with computing platform 204, mark one or more e-mail messages in folder 1 to be moved to another folder. In this example, the one or more e-mail messages marked to be moved may not be immediately moved. For example, the one or more e-mail messages marked to be moved may be displayed to a user as having been moved. However, those one or more e-mail messages marked to be moved may still be associated with folder 1 at computing platform 202. For example, those e-mail messages marked to be moved may include a tag indicating that they are to be moved during system maintenance. Furthermore, the metadata file may be updated, such that a number of files to be moved may be included in a description of any applicable folders or virtual sub-folders. In an embodiment, the system maintenance process may at least in part in response to examining the updated metadata file determine that it may be desirable to process e-mails marked to be moved. For example, if a quantity of e-mail marked to be moved in a folder or any virtual-subfolder exceeds a threshold range, such as 100 to 300 e-mails marked to be moved, a percentage of e-mail marked to be moved, such as 1 to 5 percent of a total quantity of e-mails in a folder or virtual sub-folder, and up to a high end value such as a quantity on the order of 10,000 e-mails marked to be moved, the system maintenance process may open corresponding folders or virtual sub-folders and process moving those e-mails. Furthermore, in addition to processing the messages marked for deletion, the system maintenance process may further update the metadata file, to indicate that a folder or virtual sub-folder no longer has pending e-mails to be moved. Alternatively, a system maintenance process may be scheduled to, from time to time, such as once a day, once a week, once a month, etc., process any e-mails marked to be moved. In this embodiment, the system maintenance process may examine the metadata file at one or more scheduled times and open any virtual sub-folders with pending e-mails to be moved at least in part to process the pending moves. Furthermore, the system maintenance process may also update the metadata file to indicate that pending moves for a folder or virtual sub-folder have been completed. It should, however, be noted that this is merely an illustrative example relating to a system maintenance process and that claimed subject matter is not limited in this regard.

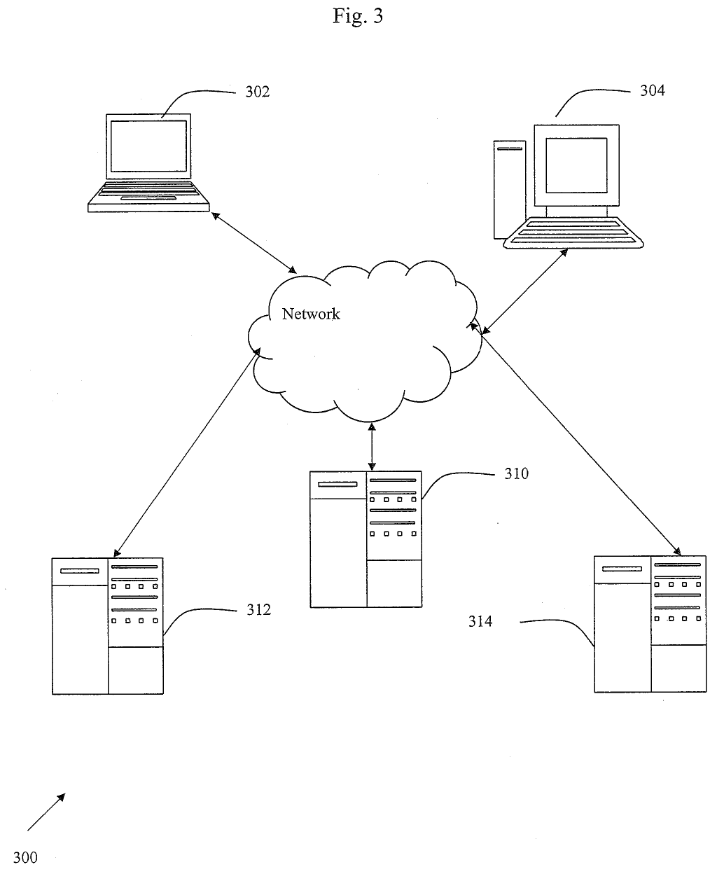

FIG. 3 is a schematic diagram of an embodiment 300, such as a system, for example. With regard to FIG. 3, a user may access a data structure, such as one or more e-mail folder, using one or more computing platforms, such as computing platforms 302 or 304. For example, a user may utilize a web browser to access an e-mail system, such as a web-based e-mail system. From a user perspective one or more e-mail folders may be presented to the user as one or more individual folders. Embodiment 300 may further include one or more computing platforms, such as computing platforms 310, 312, and 314, for example, at least in part for hosting an e-mail system. In an embodiment, a combination of computing platforms 310, 312, or 312 may comprise back-end storage, e-mail folders, virtual sub-folders, metadata folders, and system process as described above with regard to FIG. 2. Furthermore, computing platforms 310, 312, and 314 may perform one or more of the actions described above with regard to FIGS. 1 and 2. For example, computing platform 310 may include back-end storage, a meta data file and one or more folders. In this example computing platforms 312 or 314 may include one or more computing platform executable modules for performing system maintenance or back-end processes. In this example, computing platforms 312 or 314 may access the metadata filed on computing platform 310 at least in part to determine whether one or more system maintenance operations, such as those described above are desirable. If one or more threshold ranges have been reached with regard to the folders or virtual subfolder computing platforms 312 or 314 may determine which system maintenance process to utilize with respect to folders or virtual sub-folders that have exceed threshold values, such as one of the system maintenance or back-end processes described above with regard to FIGS. 1 and 2. For example, computing platforms 312 or 314 may, at least in part, create one or more virtual sub-folders at computing platform 310. In this example, computing platform 310 may associate subsequent messages intended for a folder to the created virtual subfolders. However, in communicating with computing platforms 302 or 304, computing platform may present one or more messages associated with different sub-folder as being present in an individual folder. In this manner a user may continue to increase a quantity of messages in a folder while computing platforms 310, 312, or 314 reduce an amount of work to maintain those folders at least in part by associating messages with virtual sub-folders and examining a metadata file associated with a folder to determine whether system maintenance processes are desirable. It should, however, be noted that this is merely an illustrative example relating to data structures or maintenance processes and claimed subject matter is not limited in this regard.

Unless specifically stated otherwise, as apparent from the following discussion, it is appreciated that throughout this specification discussions utilizing terms such as “processing”, “computing”, “calculating”, “selecting”, “forming”, “initiating”, “querying”, “obtaining”, “representing”, “modifying”, “receiving”, “transmitting”, “storing”, “analyzing”, “creating”, “contracting”, “associating”, “updating”, “determining”, and/or the like refer to the actions or processes that may be performed by a computing platform, such as a computer or a similar electronic computing device, that manipulates or transforms data represented as physical, electronic or magnetic quantities or other physical quantities within the computing platform's processors, memories, registers, or other information storage, transmission, reception or display devices. Accordingly, a computing platform refers to a system or a device that includes the ability to process or store data in the form of signals. Thus, a computing platform, in this context, may comprise hardware, software, firmware or any combinations thereof. Further, unless specifically stated otherwise, a process as described herein, with reference to flow diagrams or otherwise, may also be executed or controlled, in whole or in part, by a computing platform.

In the preceding description, various aspects of claimed subject matter have been described. For purposes of explanation, specific numbers, systems or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes, or equivalents will now occur to those skilled in the art. It is, therefore, to be understood that the appended claims are intended to cover all such modifications or changes as fall within the true spirit of claimed subject matter.

1. A method comprising:
examining a meta data file, file associated with a data structure at least in part to determine if one or more threshold ranges have been satisfied for one or more portions of said data structure; and
determining an action to perform on at least one of the one or more portions of said data structure if one of the one or more threshold ranges has been satisfied.

2. The method of claim 1, wherein said data structure comprises an e-mail folder.

3. The method of claim 2, wherein said action comprises creating one or more virtual sub-folders for said e-mail folder.

4. The method of claim 3, wherein said action comprises removing one of the one or more virtual sub-folders and re-assigning one or more messages associated with the removed virtual sub-folder.

5. The method of claim 2, wherein said action comprises deleting one or more messages from said e-mail folder or moving one or more messages to another e-mail folder.

6. The method of claim 3, and further comprising: updating said metadata file based at least in part on one or more changes to said e-mail folder.

7. The method of claim 3, wherein said threshold range comprises a quantity of e-mail messages associated with said e-mail folder or a virtual sub-folder.

8. An article comprising: a storage medium having stored thereon instructions that, if executed by a computing platform, are adapted to enable said computing platform to:
examine a metadata file associated with a data structure at least in part to determine if one or more threshold ranges have been satisfied for one or more portions of said data structure; and
determine an action to perform on at least one of the one or more portions of said data structure if one of the one or more threshold ranges has been satisfied.

9. The article of claim 8, wherein said data structure comprises an e-mail folder.

10. The article of claim 9, wherein said instructions, if executed by a computing platform, are further adapted to enable said computing platform to create one or more virtual sub-folders for said e-mail folder.

11. The article of claim 10, wherein said instructions, if executed by a computing platform, are further adapted to enable said computing platform to remove one of the one or more virtual sub-folders and re-assign one or more messages associated with the removed virtual sub-folder.

12. The article of claim 9, wherein said instructions, if executed by a computing platform, are further adapted to enable said computing platform to delete one or more messages from said e-mail folder or to move one or more messages to another e-mail folder.

13. The article of claim 10, wherein said instructions, if executed by a computing platform, are further adapted to enable said computing platform to update said metadata file based at least in part on one or more changes to said e-mail folder.

14. The article of claim 10, wherein said threshold range comprises a quantity of e-mail messages associated with said e-mail folder or a virtual sub-folder.

15. A system comprising:
a computing platform adapted to examine a metadata file associated with a data structure at least in part to determine if one or more threshold ranges have been satisfied for one or more portions of said data structure; and
said computing platform further adapted to determine an action to perform on at least one of the one or more portions of said data structure if one of the one or more threshold ranges has been satisfied.

16. The system of claim 15, wherein said data structure comprises an e-mail folder.

17. The system of claim 16, wherein said computing platform is further adapted to create one or more virtual sub-folders for said e-mail folder.

18. The system of claim 17, wherein said computing platform is further adapted to remove one of the one or more virtual sub-folders and re-assign one or more messages associated with the removed virtual sub-folder.

19. The system of claim 16, wherein said computing platform is further adapted to delete one or more messages from said e-mail folder or to move one or more messages to another e-mail folder.

20. The system of claim 17, wherein said computing platform is further adapted to update said metadata file based at least in part on one or more changes to said e-mail folder.

21. The system of claim 17, wherein said threshold range comprises a quantity of e-mail messages associated with said e-mail folder or a virtual sub-folder.
